(19) United States
(12) Patent Application Publication
(10) Pub. No.: US 2016/0219552 A1
(43) Pub. Date: Jul. 28, 2016

(54) Positioning method, positioning system, and access point utilizing the same

(71) Applicant: AthenTek Incorporated, Taipei City (TW)

(72) Inventor: Chun-Nan Chen, Taipei City (TW)

(21) Appl. No.: 14/701,226

(22) Filed: Apr. 30, 2015

Related U.S. Application Data
(60) Provisional application No. 62/106,948, filed on Jan. 23, 2015.

(51) Int. Cl. H04W 64/00; H04W 8/00

(52) U.S. Cl. CPC H04W 64/006; H04W 8/005; H04W 88/08

(57) ABSTRACT

A positioning method, a positioning system, and an access point utilizing the same are provided. The positioning method, adopted by a positioning system, including: determining, by an access point, whether a mobile device is present in radio coverage; and transmitting, by the access point, information of the mobile device along with information of the access point to a positioning server after determining that the mobile device is present in the radio coverage.

### CROSS REFERENCE TO RELATED APPLICATIONS

This application claims priority of U.S. Provisional Application No. 62/106,948, filed on Jan. 23, 2015, and the entirety of which is incorporated by reference herein.

### BACKGROUND OF THE INVENTION

1. Field of the Invention

The present invention relates to object positioning, and in particular to a positioning method, a positioning system, and an access point utilizing the same.

2. Description of the Related Art

Mobile devices nowadays can determine their locations by a radio signal source composition, navigation signals from a satellite system (e.g., global positioning system or GPS), or an assistant navigation system (e.g., Assistant GPS or AGPS) and then connect to a remote cloud-based server to provide location-based services (LBS) based on the location. LBS include services to identify a location of a person or object, such as tracking friends' or children's locations based on their current location.

As wireless communication is rapidly growing, the demands for increased power efficiency and an extended battery life become ever-increasing. Nevertheless, the positioning applications and the LBS applications have added considerable power requirements to mobile devices, as these applications frequently employ long-range communication to receive navigation data and upload the positioning information.

Therefore, a positioning method, a positioning system, and an access point utilizing the same are in need to reduce power requirement, extend battery life, while still being able to identify a location of a tracked object.

### BRIEF SUMMARY OF THE INVENTION

A detailed description is given in the following embodiments with reference to the accompanying drawings.

An embodiment of a positioning method is described, adopted by a positioning system, comprising: determining, by an access point, whether a mobile device is present in radio coverage; and transmitting, by the access point, information of the mobile device along with information of the access point to a positioning server after determining that the mobile device is present in the radio coverage.

Another embodiment of a positioning system is revealed, comprising a an access point and a positioning server. The access point is configured to determine whether a mobile device is present in radio coverage, and transmit information of the mobile device along with information of the access point to the positioning server after determining that the mobile device is present in the radio coverage. The positioning server, connected to the access point, is configured to receive the information of the mobile device and the information of the access device from the access point.

Another embodiment of an access point is provided, comprising a detection circuit and a tracking information transmission circuit. The detection circuit is configured to detect whether a mobile device is present in radio coverage. The tracking information transmission circuit is configured to transmit information of the mobile device along with information of the access point to a positioning server after detecting that the mobile device is present in the radio coverage.

### BRIEF DESCRIPTION OF THE DRAWINGS

The present invention can be more fully understood by reading the subsequent detailed description and examples with references made to the accompanying drawings, wherein:

FIG. 1 is a block diagram of a positioning system 1 according to an embodiment of the invention;

FIG. 2 illustrates a positioning example according to an embodiment of the invention;

FIG. 3 is a block diagram of an access point 3 according to an embodiment of the invention;

FIG. 4 is a block diagram of a positioning server 40 according to an embodiment of the invention; and

FIG. 5 is a flowchart of a positioning method 5 according to an embodiment of the invention.

### DETAILED DESCRIPTION OF THE INVENTION

The following description is of the best-contemplated mode of carrying out the invention. This description is made for the purpose of illustrating the general principles of the invention and should not be taken in a limiting sense. The scope of the invention is best determined by reference to the appended claims.

Various aspects are described herein in connection with a tracking device, which can also be referred to as a wireless communication device, a mobile device, a mobile station, a system, a device, a wireless terminal, a subscriber unit, a subscriber station, a mobile, a remote station, a remote terminal, an access terminal, a user terminal, a terminal, a communication device, a wireless device, a portable communication device, a user agent, a user device, or user equipment (UE). The mobile device may be a cellular telephone, a smartphone, a pager, a media player, a gaming console, a Session Initiation Protocol (SIP) phone, Personal Digital Assistant (PDA), a tablet computer, a laptop computer, a handheld device having wireless connection capability, a computing device, or any processing device connected to a wireless modem. Further, various embodiments described herein are associated with an access point (AP), which may be a Wireless Fidelity (WiFi) AP or a Bluetooth device operating in a short range communication network such as a Wireless Local Area Network (WLAN) or a Personal Area Network (PAN). A subscription device in various embodiments in the invention is a device which subscribe to a tracking service for tracking a tracking device, and may be a smart phone, a desktop computer, a tablet computer, a laptop computer, or any computing device.

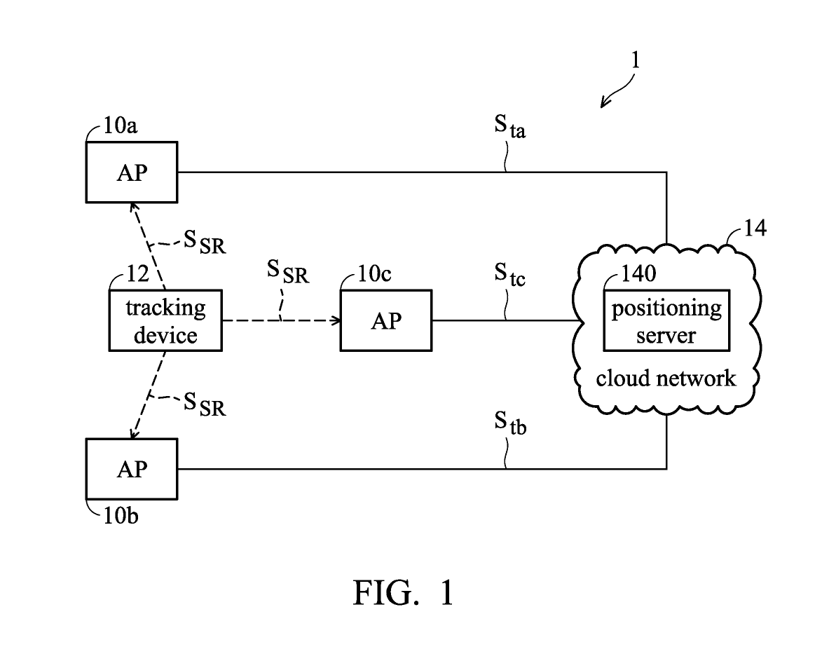

FIG. 1 is a block diagram of a positioning system 1 according to an embodiment of the invention, including APs 10a through 10c, a tracking device 12, and a cloud network 14 which contains a positioning server 140.

The APs 10a through 10c may be placed in various limited public areas such as a retail store, a school, a hospital, or a government agency, and may be connected to the cloud network 14 through an Internet (not shown). In operation, the positioning server 140 in the cloud network 14 may receive locations of the tracking device 12 via the APs 10a through 10c, which are then reported to a subscription device (not shown).

The tracking device 12 is a short-range transmitter device which may be carried on or worn by a moving object such as a person, a pet, or a vehicle. The tracking device 12 may broadcast its device identifier via a short-range radio signal S_{SR} as a tracked object moves from one place to another. When the tracked object moves into the radio coverage of the APs 10a through 10c, the APs 10a through 10c may detect presence of the tracking device 12 by receiving the short-range radio signal S_{SR}. Since the short-range radio signal S_{SR} is only transmitted in a limited range, such as a WiFi range, the tracking device 12 requires less power to broadcast its presence to a short-range AP than transmitting its location to a long-range base station. Consequently the battery life of the tracking device 12 may be extended.

Upon detecting the tracking device 12, the APs 10a, 10b and 10c may transmit tracking information via tracking signals Sₜₐ, S_{tb} and S_{tc} to the positioning server 140. The tracking information includes information of the tracking device 12 (mobile device) and information of the AP 10a, 10b, or 10c. Specifically, the information of the tracking device 12 may include, but is not limited to, the device identifier of the tracking device 12, a time log which records the time when the tracking device 12 is identified by the AP 10a, 10b, or 10c as being present in the coverage, and a signal strength of the short-range signal S_{SR} picked up by the AP 10a, 10b, or 10c. The information of the AP 10a, 10b, or 10c may include, but is not limited to, a device identifier thereof.

The positioning server 140 may acquire the tracking signals Sₜₐ, S_{tb} and S_{tc} from the APs 10a, 10b and 10c to determine whether to track the location of the tracking device 12 or not. This may be done by comparing the device identifier of the tracking device 12 to a tracking list. When a match of the device identifier of the tracking device 12 is found in the tracking list, the positioning server 140 may track down the location of the tracking device 12, whereas when no match of the device identifier of the tracking device 12 is found in the tracking list, the positioning server 140 may stop the tracking operation. The tracking list may be established at the positioning server 140 when a tracking service is subscribed.

When the tracking device 12 is subscribed in the tracking service, the positioning server 140 may identify the location of the tracking device 12 based on the information of the APs. When the APs 10a, 10b and 10c are disposed closely, they may detect the short-range radio signal S_{SR} from the tracking device 12 at substantially the same time, and the location of the tracking device 12 may be determined based on the information of the APs 10a, 10b and 10c. On the other hand, when the APs 10a, 10b and 10c are disposed at different places, they may pick up the short-range radio signal S_{SR} from the tracking device 12 at different times, and the positioning server 140 may establish a tracking route of the tracking device 12 according to the time log and the access point identifiers included in the tracking signals Sₜₐ, S_{tb} and S_{tc}.

Specifically, the positioning server 140 may contain a location list of all available AP entries or location entries, and the location of the tracking device may be determined as an absolute location or a relative location. Each AP entry may include a device identifier and a corresponding geographic coordinate of an AP, and each location entry may include a location name and device identifiers and signal strengths of one or more APs. For the absolute location, the positioning server 140 may determine the location of the tracking device 12 by finding geographic coordinates of the APs 10a, 10b or 10c from the location list according to the device identifiers of the APs 10a, 10b or 10c in the tracking signals Sₜₐ, S_{tb} or S_{tc} and then averaging the geographic coordinates of the APs 10a, 10b or 10c. For the relative location, the positioning server 140 may determine the location of the tracking device 12 as the location name by finding a corresponding match of device identifiers and signal strengths of the APs 10a, 10b or 10c to location entries in the location list, where each location entry contains device identifiers and signal strengths of a collection of APs.

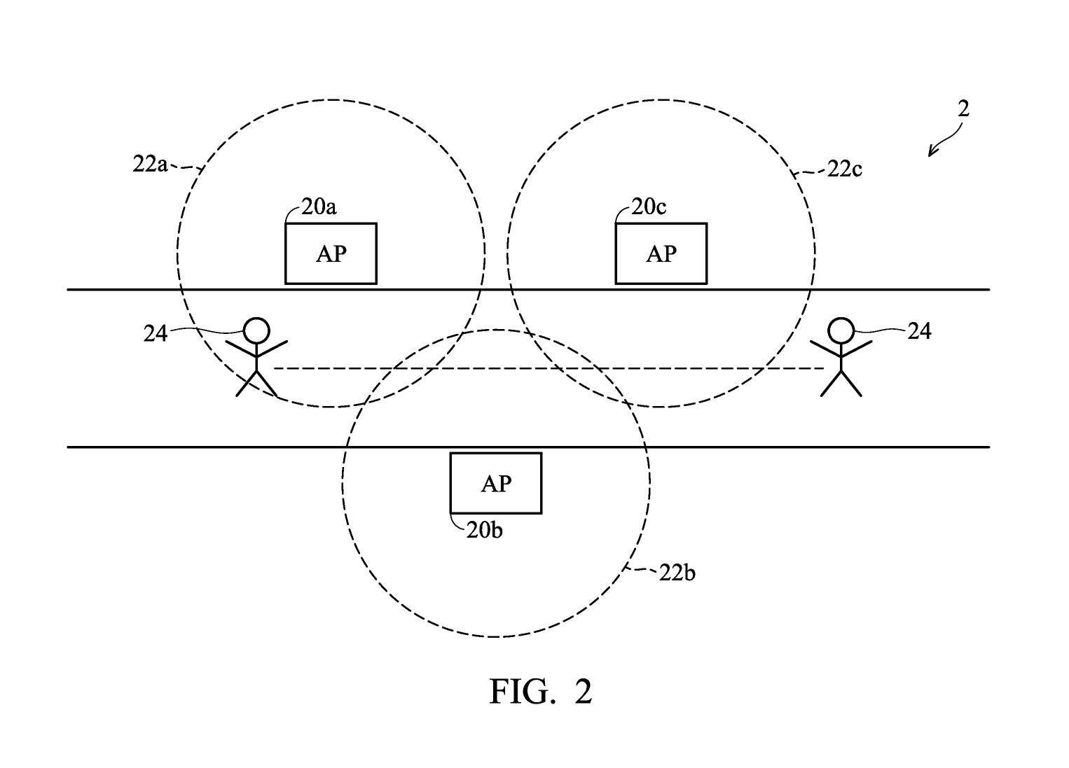

The tracking route of the tracking device 12 may be constructed by marking the locations determined by the positioning server 140 in time order. An example of the tracking route is described in FIG. 2. The positioning server 140 then may report the location or the tracking route of the tracking device 12 to the subscription device, informing the subscription device of the whereabouts of the tracking device 12 in real time.

The positioning system 1 allows the tracking device 12 to cut down the power requirement by broadcasting its presence using a short-range signal, and consequently, the APs 10a, 10b, or 10c may detect the tracking device 12 as it moves into the radio coverage, and the positioning server 140 may determine the location(s) of the tracking device 12 according to the information of the tracking device 12 and the APs 10a, 10b, or 10c transmitted from the APs 10a, 10b, or 10c. As a result, the positioning system 1 allows the tracking device 12 to have an extended battery life, while the positioning server 140 is still able to determine the location(s) of the tracking device 12 by the information of the tracking device 12 and the APs transmitted from the APs 10a, 10b, or 10c.

FIG. 2 illustrates a positioning example according to an embodiment of the invention, a children 24 may carry a tracking device as he or she walks along a street, where APs 20a, b, and c are disposed along various locations on the street.

As shown in FIG. 2, the APs 20a, b, and c may have a coverage range 22a, b, and c, respectively. As the children 24 walks along the street, a tracking device will broadcast a device identifier to the surrounding, and one or more of the APs 20a, b and c may detect the tracking device. The APs 20a, b, and c are arranged in such a way that the radio coverage 22a of the AP 20a is slightly overlapped with the radio coverage 22b of the AP 20b, and the radio coverage 22c of the AP 20c is slightly overlapped with the radio coverage 22b of the AP 20b. Consequently, one or more APs will “see” the children 24 as he or she passes different locations on the street.

In one example, the children 24 enters the radio coverage 22a of the AP 20a at a time interval between 11:20 am to 11:26 am, the radio coverage 22b of the AP 20b at a time interval between 11:25 am to 11:30 am, and the radio coverage 22c of the AP 20c at a time interval between 11:28 am to 11:35 am. Accordingly, the APs 20a, b, and c may transmit the tracking signals to the positioning server via internet upon detecting the tracking device. Therefore, the positioning server may determine that the children 24 is in the sole range of the AP 20a at a time interval between 11.20 am to 11:25 am, in the overlapped range of the APs 20a and 20b at a time interval between 11.25 am to 11:26 am, in the sole range of the AP 20b at a time interval between 11.26 am to 11:30 am, in the overlapped range of the APs 20b and 20c at a time interval between 11.28 am to 11:30 am, and in the sole range of the AP 20c at a time interval between 11.30 am to 11:35 am. Based on the time sequence, the positioning server may track down the walking path of the children 24 and depict a tracking route as a collection of the determined locations of the tracking device arranged in time order.

The positioning method described in FIG. 2 allows the tracking device to reduce the power requirement by broadcasting its presence using a short-range signal, while the location(s) or tracking of a user of the tracking device may still be accurately determined by the positioning server using the information transmitted by the APs.

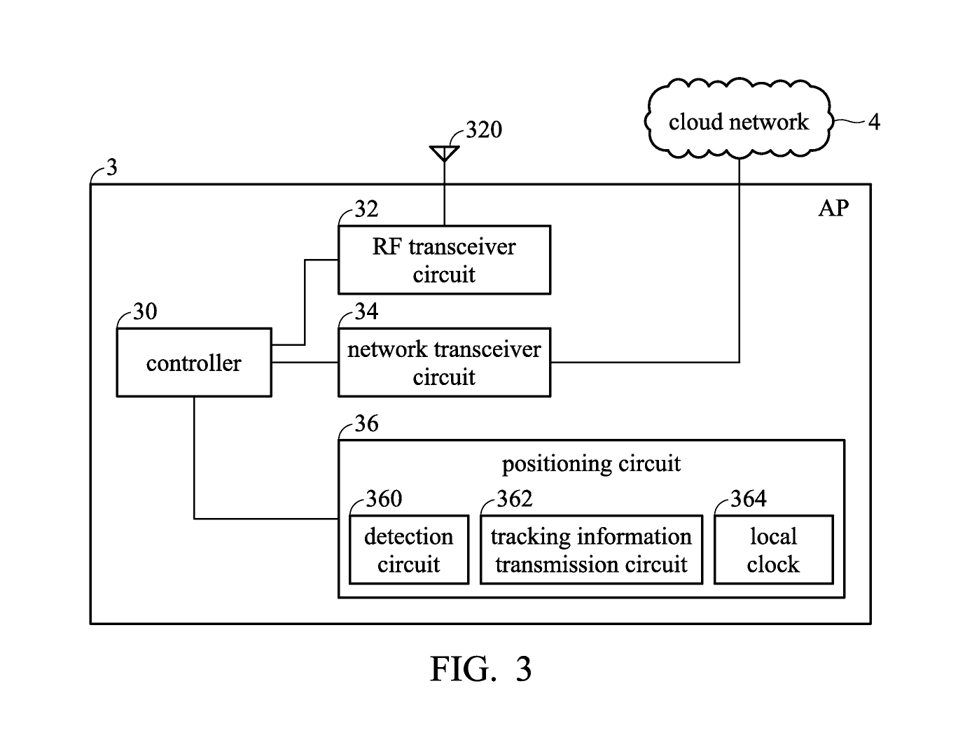

FIG. 3 is a block diagram of an access point 3 according to an embodiment of the invention, including a controller 30, an RF transceiver circuit 32, an antenna 320, a network transceiver circuit 34, and a positioning circuit 36. The access point 3 may be used as the APs 10a, 10b, and 10c in FIG. 1, which may constantly monitor any mobile device present in the radio coverage, and once a mobile device is detected, it may transmit information of the mobile device and the access point to the positioning server in the cloud network. Because the access point 3 is a fixed device, it may be powered by a power supply that does not have a battery life issue.

The controller 30 is coupled to the RF transceiver circuit 32, the network transceiver circuit 34, and the positioning circuit 36 to control the operations thereof.

The RF transceiver circuit 32 and the antenna 320 are configured to receive a short-range signal S_{SR} broadcasted by a mobile device, and may be a WiFi transceiver circuit. Upon detecting the short-range signal S_{SR} from the mobile device, the network transceiver circuit 34 is configured to transmit a tracking signal Sₜ which contains the information of the mobile device and the access point to the cloud network 4 via a wired connection.

The positioning circuit 36 is configured to detect any mobile device present in the radio coverage of the access point 3, and generate the information of the mobile device and the access point for sending to the cloud network 4 after a mobile device is detected. The positioning circuit 36 includes a detection circuit 360, a tracking information transmission circuit 362, and a local clock 364.

After power is turned on or the tracking function is initiated, the detection circuit 360 is configured to constantly monitor for a mobile device in the coverage range of the access point 3 by detecting a short-range signal S_{SR} which contains the device identifier of the mobile device.

In turn, upon detecting that the mobile device is present in the coverage range, the tracking information transmission circuit 362 is configured to obtain a detection time from the local clock and the device identifier of the detected mobile device from the short-range signal S_{SR} to generate the information of the mobile device, and generate the information of the access point 3 according to the device identifier thereof. The tracking information transmission circuit 362 is configured to transmit the information of the mobile device along with the information of the access point 3 via the network transceiver circuit 34 to a positioning server (not shown) in the cloud network 4. The information of the mobile device may include, but is not limited to, the device identifier of the mobile device, a time log which records the time when the mobile device is identified, and a signal strength of the short-range signal S_{SR} picked up by the AP 3.

The positioning circuit 36 may be implemented by hardware circuits, or software codes loadable and executable by the controller 30.

The AP 3 is utilized in a positioning system to detect a short-range signal of a tracking device, and transmit the information of the tracking device the AP3 to a positioning server for determining the location(s) or tracking of a user of the tracking device.

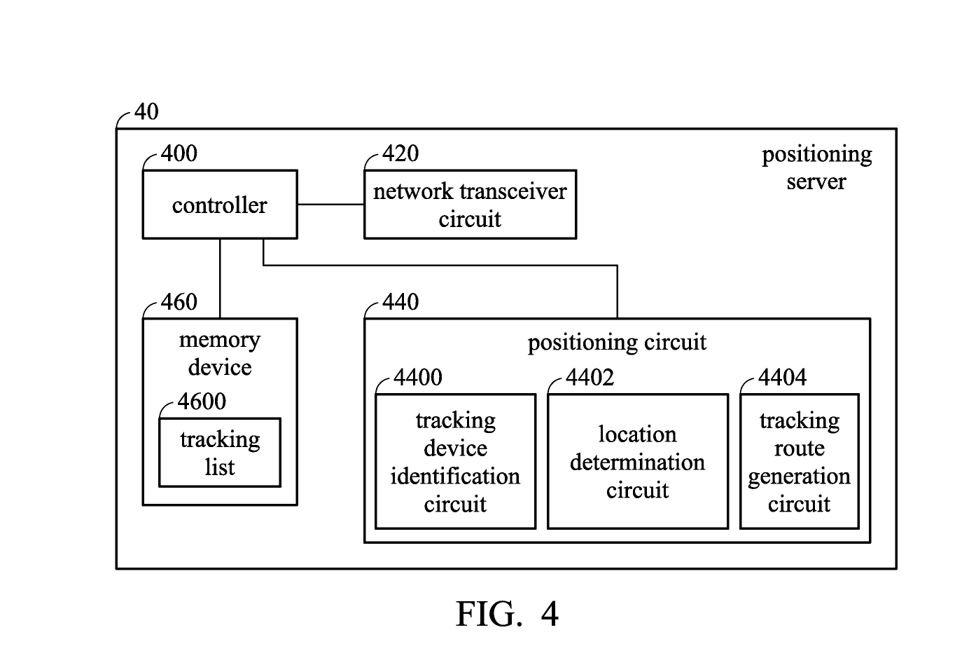

FIG. 4 is a block diagram of a positioning server 40 according to an embodiment of the invention, including a controller 400, a network transceiver circuit 420, a positioning circuit 440 and a memory device 460. The positioning server 40 may be used as the positioning server 140 in FIG. 1, which may identify a tracking device, and determine a location or a tracking route of the tracking device after the tracking device is identified. The positioning server 40 is a server in a cloud network, and may collect one or more tracking signals Sₜ from connected APs (not shown), wherein each tracking signals Sₜ contains information of the mobile device and information of the access point.

The controller 400 is coupled to the RF transceiver circuit 420, the network transceiver circuit 440, and the positioning circuit 460 to control the operations thereof.

The network transceiver circuit 420 is configured to receive the tracking signal Sₜ from connected APs via a wired connection.

After power is turned on or the tracking function is activated, the positioning circuit 440 is configured to determine whether the mobile device is a subscribed tracking device, when the mobile device is a subscribed tracking device, determine the location or the tracking route of the tracking device, and report the location or the tracking route of the tracking device to a subscription device such as a remote desktop computer. The positioning circuit 440 may contain a tracking device identification circuit 4400, a location determination circuit 4402, and a tracking route generation circuit 4404.

The tracking device identification circuit 4400 is configured to determine whether the mobile device is a tracking device according to the information of the mobile device, which contains a device identifier of the mobile device. The tracking device identification circuit 4400 is configured to compare the device identifier of the mobile device to a tracking list 4600 stored in the memory device 460. The tracking list 4600, established at the time when a tracking service is subscribed, is a list of device identifiers of subscribed tracking devices that positioning server 40 may follow. When a match of the device identifier of the mobile device is found in the tracking list, the tracking device identification circuit 4400 is configured to determine that the mobile device is a tracking device. Conversely, when no match is found in the tracking list, the tracking device identification circuit 4400 is configured to determine that the mobile device is not a tracking device.

When the mobile device is a tracking device, the location determination circuit 4402 is configured to determine the location of the mobile device according to the information of the access point, which contains a device identifier of the AP which detects the mobile device. The location determination circuit 4402 is configured to determine the location of the tracking device according to location entries stored in a location list (not shown) stored in the memory device 460. The location of the tracking device may be an absolute location or a relative location. In one embodiment, when the positioning server 40 receives tracking signals Sₜ from one or more APs, an absolute location of the tracking device may be computed by finding geographic coordinates of the one or more APs from the location list according to the device identifiers of the one or more APs in the tracking signals Sₜ and then averaging the geographic coordinates of the one or more APs. In another embodiments, when the positioning server 40 receives tracking signals Sₜ from one or more APs, a relative location of the tracking device may be determined by finding a match of device identifiers and signal strengths of the one or more APs which send the tracking signals Sₜ to location entries in the location list, where each location entry contains device identifiers and signal strengths of a collection of APs. In some embodiments, the location determination circuit 4402 may be configured to further report the location of the tracking device to a subscription device such as a desktop computer via a wired or wireless connection (not shown).

When the mobile device is not a tracking device, the location determination circuit 4402 may still determine the location of the mobile device according to the information of the access point, but instead of forwarding the location of the mobile device to a subscription device, the location determination circuit 4402 may hold the location of the mobile device in a local memory device (not shown) of the positioning server 40 for later uses, e.g., providing the location of a missing person, a missing pet, or a missing object which carries the mobile device to the police under an emergency condition.

Next, the tracking route generation circuit 4404 is configured to establish a tracking route of the tracking device according to the access point identifier and the time when the mobile device is detected by the access points, wherein the time when the mobile device is detected by the APs may be retrieved from the information of the mobile device in the tracking signals Sₜ, and the access point identifier may be retrieved from the information of the access point in the tracking signals Sₜ. Specifically, the tracking route may be generated as a collection of the locations of the tracking device determined by the location determination circuit 4402, arranged in time order. In some embodiments, the tracking route generation circuit 4404 may be configured to further report the tracking route to a subscription device such as a desktop computer via a wired or wireless connection (not shown). In other embodiments, when the mobile device is not a tracking device, the tracking route generation circuit 4404 may keep the tracking route of the mobile device in the local memory device of the positioning server 40 for uses under an emergency condition.

The positioning circuit 440 may be implemented by hardware circuits, or software codes loadable and executable by the controller 400.

The positioning server 40 receives the information of a tracking device and an AP from the AP to accurately determine the location(s) or a tracking route of the tracking device.

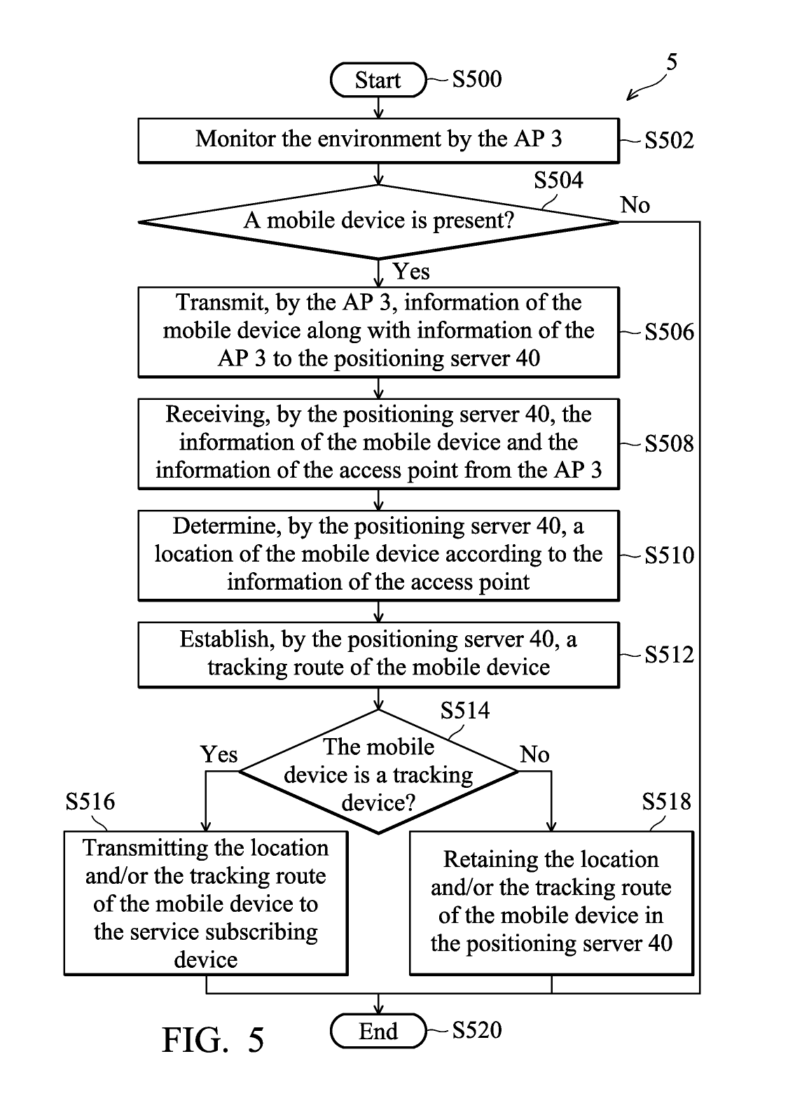

FIG. 5 is a flowchart of a positioning method 5 according to an embodiment of the invention, incorporating the AP 3 in FIG. 3 and the positioning server 40 in FIG. 4. The positioning method 5 is initiated upon power-up or after a tracking function is activated (S500). After initialization, the AP 3 may constantly and periodically monitor the radio environment (S502), and determine whether a mobile device is present in the radio coverage of the AP 3 by receiving a tracking signal Sₜ broadcasted by a short-range mobile device (S504). The tracking signal Sₜ may contain the device identifier of the mobile device, which may be used by the AP3 to determine that a valid mobile device has been received. When there is no mobile device in range, the positioning method 5 jumps to Step S520 and exits.

After determining the presence of the mobile device, the AP may transmit the information of the mobile device along with the information of the AP 3 to the positioning server 40 (S506). The information of the mobile device may contain, but is not limited to, the device identifier of the mobile device and the time when the mobile device is detected, and a signal strength of the short-range signal S_{SR} picked up by the AP 3. The information of AP 3 may contain, but is not limited to, the device identifier of the AP3.

Correspondingly, the positioning server 40 may receive the information of the mobile device and the information of the access point from the AP 3 (S508), and the location of the mobile device according to the information of the AP 3 (S510). Further, the positioning server 40 may establish the tracking route of the mobile device according to the access point identifier and the time when the mobile device is detected by the access points (S512), wherein the time when the mobile device is detected by the APs may be retrieved from the information of the mobile device in the tracking signals Sₜ, and the access point identifier may be retrieved from the information of the access point in the tracking signals Sₜ. Specifically, the tracking route may be generated as a collection of the locations of the tracking device determined in Step S510, arranged in time order. In some embodiments, the positioning server 40 may further report the location or the tracking route to a subscription device such as a desktop computer via a wired or wireless connection (not shown).

In step S510, the location of the tracking device may be determined as an absolute location or a relative location. For the absolute location, the positioning server 40 may determine the location of the tracking device by finding geographic coordinates of the one or more APs from the location list according to the device identifiers of the APs in the tracking signals Sₜ and then averaging the geographic coordinates of the one or more APs. For the relative location, the positioning server 40 may determine the location of the tracking device by finding a match of device identifiers and signal strengths of the APs to location entries in the location list, where each location entry contains device identifiers and signal strengths of a collection of APs.

Next, the positioning server 40 may determine whether the mobile device is a tracking device by comparing the device identifier of the mobile device to the tracking list (S514). The tracking list, established at the time when a tracking service is subscribed, is a list of device identifiers of subscribed tracking devices that positioning server 40 may follow. When a match of the device identifier of the mobile device is found in the tracking list, the positioning server 40 may determine that the mobile device is a tracking device and continue to transmit the location and/or the tracking route of the mobile device to the subscription device (S516). Conversely, when no match is found in the tracking list, the positioning server 40 may determine that the mobile device is not a tracking device, and retain the location and/or the tracking route of the mobile device locally in the position server 40 for special uses such as a missing person report (S518).

After Steps S516 or S518, the positioning method 5 is then completed and exited (S520).

The positioning method 5 allows the tracking device to reduce the power requirement by broadcasting its presence using a short-range signal, while the location(s) or tracking of a user of the tracking device may still be accurately determined by the positioning server 40 using the information transmitted by the AP 3.

As used herein, the term “determining” encompasses calculating, computing, processing, deriving, investigating, looking up (e.g., looking up in a table, a database or another data structure), ascertaining and the like. Also, “determining” may include resolving, selecting, choosing, establishing and the like.

The various illustrative logical blocks, modules and circuits described in connection with the present disclosure may be implemented or performed with a general purpose processor, a digital signal processor (DSP), an application-specific integrated circuit (ASIC), a field programmable gate array signal (FPGA) or another programmable logic device, discrete gate or transistor logic, discrete hardware components or any combination thereof designed to perform the functions described herein. A general-purpose processor may be a microprocessor, but in the alternative, the processor may be any commercially available processor, controller, microcontroller or state machine.

The operations and functions of the various logical blocks, modules, and circuits described herein may be implemented in circuit hardware or embedded software codes that can be accessed and executed by a processor.

While the invention has been described by way of example and in terms of the preferred embodiments, it is to be understood that the invention is not limited to the disclosed embodiments. On the contrary, it is intended to cover various modifications and similar arrangements (as would be apparent to those skilled in the art). Therefore, the scope of the appended claims should be accorded the broadest interpretation so as to encompass all such modifications and similar arrangements.

What is claimed is:

1. A positioning method, adopted by a positioning system, comprising:
determining, by an access point, whether a mobile device is present in radio coverage; and
transmitting, by the access point, information of the mobile device along with information of the access point to a positioning server after determining that the mobile device is present in the radio coverage.

2. The positioning method of claim 1, further comprising:
receiving, by the positioning server, the information of the mobile device and the information of the access device from the access point;
determining, by the positioning server, a location of the mobile device according to the information of the access point;
determining, by the positioning server, whether the mobile device is a tracking device according to the information of the mobile device; and
when the mobile device is a tracking device, transmitting, by the positioning server, the location of the mobile device to a subscription device.

3. The positioning method of claim 2, wherein the step of the determining
whether the mobile device is a tracking device comprises:
comparing, by the positioning server, the information of the mobile device to a tracking list; and
determining, by the positioning server, that the mobile device is a tracking device when a match of the information of the mobile device is found in the tracking list.

4. The positioning method of claim 3, wherein the step of the determining
whether the mobile device is a tracking device further comprises:
determining, by the positioning server, that the mobile device is not a tracking device when no match of the information of the mobile device is found in the tracking list; and
the positioning method further comprises:
when the mobile device is not a tracking device, retaining, by the positioning server, the location of the mobile device without further transmitting the location of the mobile device to the subscription device.

5. The positioning method of claim 1, wherein the information of the mobile device comprises a mobile device identifier and a time at which the mobile device is detected by the access point, and the information of the access point comprises an access point identifier.

6. The positioning method of claim 4, further comprising:
when the mobile device is a tracking device, establishing, by the positioning server, a tracking route of the mobile device according to the time the access point identifier and the time when the mobile device is detected by the access point.

7. A positioning system, comprising:
an access point, configured to determine whether a mobile device is present in radio coverage, and transmit information of the mobile device along with information of the access point to a positioning server after determining that the mobile device is present in the radio coverage; and
the positioning server, connected to the access point, configured to receive the information of the mobile device and the information of the access device from the access point.

8. The positioning system of claim 7, wherein the positioning server is configured to determine a location of the mobile device according to the information of the access point, determine whether the mobile device is a tracking device according to the information of the mobile device, and when the mobile device is a tracking device, transmit the location of the mobile device to a subscription device.

9. The positioning system of claim 8, wherein the positioning server is configured to compare the information of the mobile device to a tracking list, and determine that the mobile device is a tracking device when a match of the information of the mobile device is found in the tracking list.

10. The positioning system of claim 9, wherein the positioning server is configured to determine that the mobile device is not a tracking device when no match of the information of the mobile device is found in the tracking list, and when the mobile device is not a tracking device, retain the location of the mobile device without further transmitting the location of the mobile device to the subscription device.

11. The positioning system of claim 7, wherein the information of the mobile device comprises a mobile device identifier and a time at which the mobile device is detected by the access point, and the information of the access point comprises an access point identifier.

12. The positioning system of claim 11, wherein the positioning server is configured to establish a tracking route of the mobile device according to the time the access point identifier and the time when the mobile device is detected by the access point.

13. An access point, comprising:
a detection circuit, configured to detect whether a mobile device is present in radio coverage; and
a tracking information transmission circuit, coupled to the detection circuit, configured to transmit information of the mobile device along with information of the access point to a positioning server after detecting that the mobile device is present in the radio coverage.

14. The access point of claim 13, wherein the information of the mobile device comprises a mobile device identifier and a time at which the mobile device is detected by the access point, and the information of the access point comprises an access point identifier.
